(19) United States
(12) Patent Application Publication
(10) Pub. No.: US 2019/0089548 A1
(43) Pub. Date: Mar. 21, 2019

(54) PACKET TRANSFER DEVICE AND PACKET TRANSFER SYSTEM

(71) Applicant: ALAXALA Networks Corporation, Kanagawa (JP)

(72) Inventor: Naohisa KOIE, Kawasaki (JP)

(21) Appl. No.: 16/018,114

(22) Filed: Jun. 26, 2018

(30) Foreign Application Priority Data
Sep. 20, 2017 (JP) 2017-180012

(51) Int. Cl. H04L 12/10; G06F 1/26; G06F 1/32

(52) U.S. Cl. CPC H04L 12/10; G06F 1/3209; G06F 1/266

(57) ABSTRACT

A packet transfer device including a PoE port includes a power supply unit that controls power supply to the PoE port and measures a power supply amount, a packet switching unit that transfers a packet via the PoE port and another port of the packet transfer device and measures a communication volume of the PoE port, a profile holding unit that holds a profile indicating a normal operation region of a device connected to the PoE port using a map of a correlation of the power supply amount and the communication volume, a correlation analyzing unit that determines whether or not the device is abnormal on the basis of the power supply amount measured by the power supply unit, the communication volume measured by the packet switching unit, and the profile held in the profile holding unit, and a CPU unit that controls the respective units of the packet transfer.

### CROSS-REFERENCE TO RELATED APPLICATION

The present application claims priority from Japanese application JP 2017-180012, filed on Sep. 20, 2017, the content of which is hereby incorporated by reference into this application.

### TECHNICAL FIELD

The present invention relates to a packet transfer device and a packet transfer system.

### BACKGROUND ART

With the advance of Internet of Things (IoT), an increase in a network size has accelerated more and more. Further, devices connected to a network have been diversified, and tasks required for managing devices connected to the network have changed greatly in terms of both quality and quantity, resulting in a very big problem.

Various methods are used for the purpose of supporting management of the devices connected to the network. For example, there is a method of installing an agent in a device and exchanging information with a manager installed in a network.

In this method, since it is possible to directly acquire information of a device to be managed, it is possible to perform fine management using information such as a utilization ratio of a central processing unit (CPU) or a memory of a device, a list of processes being activated, an infection state to malware, a login state of a user, or the like.

Meanwhile, devices in which the agent can be installed are often limited depending on a type of operating system (OS) or hardware, and there are many cases in which the agent is unable to be introduced. In the future, such cases will be further increased since more various devices are expected to be connected to the network.

Further, since the device does not operate normally in a situation where the device is infected by malware or malfunctions, the agent is unlikely to operate normally, and thus it is effective to use indirect management from the outside of the device together.

Examples of the indirect management method from the outside of the device include a method of measuring a communication volume of a device through a network device and determining that there is a possibility that it will be infected by malware when a communication volume becomes an unexpected volume, a method of measuring power consumption of a device and determining that the device performs an unexpected operation when the power consumption is unexpected power consumption, and a method of transferring a specific command (ping, a get method of http, or the like) to a device of a management target from a device other than the device and determining that there is a failure in the device or a specific process shuts down.

In such indirect management methods from the outside of the device, detailed information inside the device such as the state of the CPU or a list of processes being operated is not acquired, but there is an advantage in that it is possible to monitor stably regardless of the state of the device.

It is the essence of an indirect management method to estimate the state of device from information measurable outside the device. As described above, examples of the information measurable outside the device includes the communication volume in the network device, power consumption in a network device capable of performing Power over Ethernet (PoE: Ethernet is a registered trademark) power supply or an uninterruptible power supply (UPS), and temperature information by a thermometer.

In the management system, a method of evaluating such information alone is common, and for example, when the temperature is very high, and the power consumption is much higher than usual, it is determined that there is a possibility of an operation of an unexpected fraudulent process or a hardware failure.

A technique of determining a possibility of an abnormality in a connected device by comparing measured data with recorded data in accordance with a predetermined determination condition in a PoE switch including a device of measuring and recording a transmission data amount and a power supply amount is disclosed in JP 2014-138369 A.

### SUMMARY OF THE INVENTION

### Problems to be Solved by the Invention

Using the technique disclosed in JP 2014-138369 A, it is possible to determine the possibility of an abnormality in the device on the basis of the transmission data amount and the power supply amount. However, there are devices in which the transmission data amount and the power supply amount largely change with a correlation under normal conditions, and if normal ranges of the transmission data amount and the power supply amount are simply set in such devices, there is a high possibility that an abnormal state is erroneously determined to be a normal state because many abnormal states are included in a simple normal range.

It is an object of the present invention to provide a packet transfer device which enables an abnormality in a connected device to be determined with detailed information.

### Solutions to Problems

An exemplary typical packet transfer device according to the present invention is a packet transfer device including a PoE port which includes a power supply unit that controls power supply to the PoE port and measures a power supply amount, a packet switching unit that transfers a packet via the PoE port and another port of the packet transfer device and measures a communication volume of the PoE port, a profile holding unit that holds a profile indicating a normal operation region of a device connected to the PoE port using a map of a correlation of the power supply amount and the communication volume, a correlation analyzing unit that determines whether or not the device is abnormal on the basis of the power supply amount measured by the power supply unit, the communication volume measured by the packet switching unit, and the profile held in the profile holding unit, and a CPU unit that controls the respective units of the packet transfer device and performs a countermeasure action on the basis of the determination of whether or not the device is abnormal by the correlation analyzing unit.

### EFFECTS OF THE INVENTION

According to the present invention, it is possible to provide a packet transfer device which enables an abnormality in a connected device to be determined with detailed information.

### BRIEF DESCRIPTION OF THE DRAWINGS

FIG. 1 is a block diagram illustrating an example of a packet transfer device having a PoE function of determining a normality in a connected device.

FIG. 2 is a diagram illustrating an example of a profile and determination based on a communication volume and a power supply amount.

FIG. 3 is a diagram illustrating an example of a communication volume.

FIG. 4 is a block diagram illustrating an example of a packet transfer device that generates a profile.

FIG. 5 is a diagram illustrating an example of a profile generated on the basis of a linear function.

FIG. 6 is a diagram illustrating an example of a profile based on an amount of change in a communication volume and a power supply amount.

FIG. 7 is a block diagram illustrating an example of a packet transfer device cooperating with a server.

FIG. 8 is a block diagram illustrating an example of a packet transfer device cooperating with a UPS.

FIG. 9 is a block diagram illustrating an example of a packet transfer device cooperating with a server and a UPS.

### MODE FOR CARRYING OUT THE INVENTION

### First Embodiment

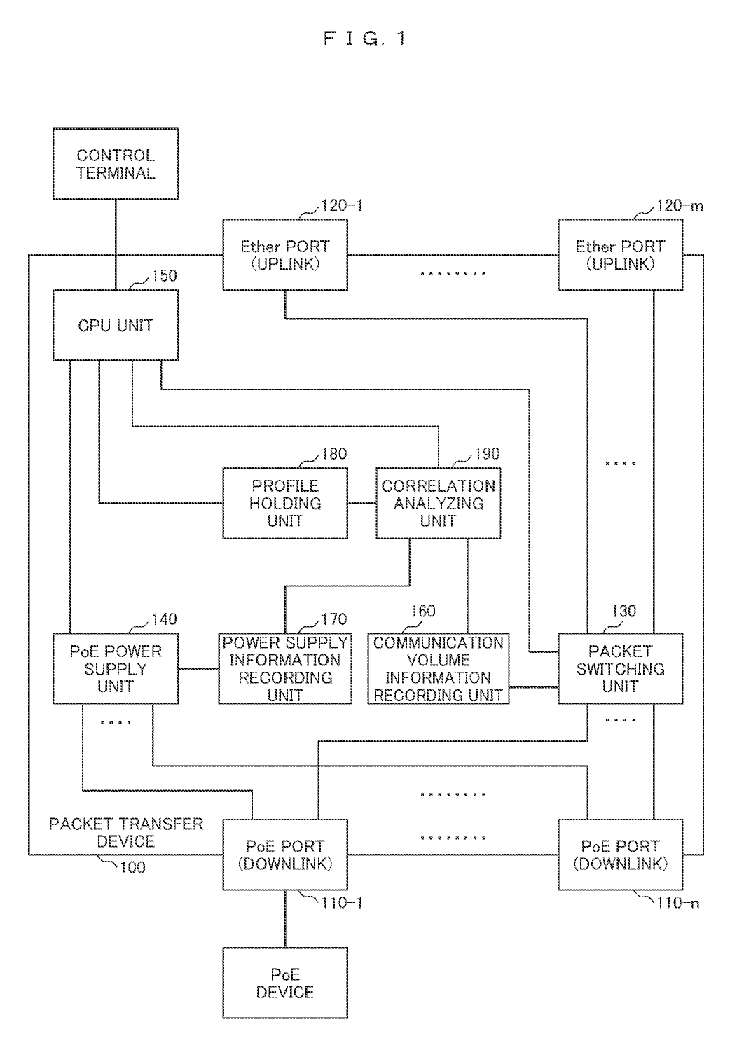

A first embodiment will be described with reference to FIGS. 1 and 2. In the first embodiment, checking of a normality of a connected device is performed in accordance with a preset profile in a packet transfer device having a PoE function.

FIG. 1 is a block diagram illustrating an example of a packet transfer device 100 having a PoE function capable of checking a normality of a connected PoE device. Similarly to a packet transfer device having a general PoE function, a PoE device is connected to the packet transfer device 100, and the packet transfer device 100 includes a PoE port 110 for supplying electric power through a PoE function and an Ether port 120 to which a high-level network device is connected.

The PoE port 110 is, for example, a downlink port, and the Ether port 120 is, for example, an uplink port. In a case in which any one of a PoE port 110-1 to a PoE port 110-n is representatively indicated without being specified, it is indicated by a PoE port 110, and the same applies to the Ether port 120. The Ether port 120 may be a communication port of a protocol other than Ethernet, and the packet transfer device 100 may convert the protocol.

The packet transfer device 100 further includes a packet switching unit 130 that transfers or blocks a packet between the PoE port 110 and the Ether port 120, a PoE power supply unit 140 that controls power supply to the PoE port 110, and a CPU unit 150 which is connected to a control terminal and functions as a process of controlling the respective units of the packet transfer device 100.

The packet transfer device 100 further includes a communication volume information recording unit 160 that records a communication volume of each PoE port 110, a power supply information recording unit 170 that records an amount of electric power being supplied to each PoE port 110, a profile holding unit 180 that holds a profile describing a correlation between a communication volume and an electric power amount of a device connected to the PoE port, and a correlation analyzing unit 190 that detects an abnormality in a device from the correlation between the communication volume and the electric power amount recorded in the profile.

A device such as an Internet protocol (IP) phone or a surveillance camera is connected to the PoE port 110, and the device is supplied with electric power via the PoE port 110 and performs communication. For packets received through the PoE port 110, an output port is decided from header information in the packet switching unit 130, and transmission is performed from the decided output port. Further, when conditions for passage of packets are set, packets that do not satisfy the conditions may be discarded.

For packets received through the Ether port 120, the PoE port 110 may be decided from header information in the packet switching unit 130, and transmission may be performed from the decided PoE port 110. When conditions for passage of packets are set even in the Ether port 120, packets that do not satisfy the conditions may be discarded. The packet switching unit 130 measures a communication volume of communication caused by passing packets. The discarded packet may be excluded from a measurement target.

The PoE power supply unit 140 controls the power supply to each PoE port 110 under the control of the CPU unit 150 and measures the power supply amount to each PoE port 110. Further, the PoE power supply unit 140 or the packet switching unit 130 may acquire information such as an identifier of the PoE device via each PoE port 110 and notify the CPU unit 150 of the acquired information.

The communication volume information recording unit 160 acquires the communication volume of each PoE port 110 from the packet switching unit 130 and records the communication volume per unit time together with a timestamp. On the other hand, the power supply information recording unit 170 acquires the power supply amount of each PoE port 110 (the power consumption amount of the device connected to the PoE port 110) from the PoE power supply unit 140 and records the power supply amount per unit time together with a timestamp.

Here, the unit time for obtaining the communication volume and the unit time for obtaining the power supply amount are preferably the same time, and the timestamp of the communication volume and the timestamp of the power supply amount are preferably common.

The profile holding unit 180 receives and stores a profile describing the correlation between the communication volume and the power supply amount to be applied in each PoE port 110 from a control terminal outside the packet transfer device 100 via the CPU unit 150. The correlation between the communication volume and the power supply amount to be applied in each PoE port 110 may be a correlation between the communication volume and the power supply amount to be applied to the device connected to each PoE port 110.

For each PoE port 110, the correlation analyzing unit 190 receives information from the communication volume information recording unit 160, information from the power supply information recording unit 170, and the profile from the profile holding unit 180 corresponding to the information, and determines whether or not the information falls within a normal range specified in the profile.

When the correlation analyzing unit 190 determines that the information is out of the normal range, that is, abnormal, the correlation analyzing unit 190 gives a notification to the CPU unit 150, and the CPU unit 150 may perform trap issuing of a simple network management protocol (SNMP), transmission of syslog information, or notification of information via an e-mail, and setting of an access control list (ACL) description to the packet switching unit 130.

Further, the CPU unit 150 may control the packet switching unit 130 or the PoE power supply unit 140 such that the PoE port 110 determined to be abnormal is inactivated or undergoes blocking of communication or interruption of power supply or may control the packet switching unit 130 such that communication related to the PoE port 110 determined to be abnormal is mirrored to another Ether port 120.

Upon receiving the notification of the determination result indicating the abnormality from the correlation analyzing unit 190, the CPU unit 150 may select one or more countermeasure actions (actions) from among the above countermeasure actions, or a countermeasure action to take may be set from the control terminal in advance.

FIG. 2 is a diagram illustrating an example of the profile and the determination. The profile is, for example, a graph in which a vertical axis indicates a power supply amount, and a horizontal axis indicates a communication volume. In the example of FIG. 2, values determined to be normal are surrounded by circles 201, 202, and 203, and in a case in which the device connected to the PoE port 110 is a surveillance camera, three operation modes of low resolution, intermediate resolution, and high resolution are supported.

When the surveillance camera is in the low resolution operation mode, the communication volume and the power consumption amount are small and have a correlation indicated by the circle 201. When the surveillance camera is in the high resolution operation mode, the communication volume and the power consumption amount are large and have a correlation indicated by the circle 203. When the surveillance camera is in the intermediate resolution operation mode, the communication volume and the power consumption amount have a correlation indicated by the circle 202 between the circle 201 and the circle 203.

In the example of the profile of FIG. 2, for example, when the recorded power supply amount and the communication volume have a correlation 212, it is determined to be normal, and when the recorded power supply amount and the communication volume have a correlation 211, it is determined to be abnormal. The state of the correlation 211 falls within an intermediate resolution range in terms of the power supply amount and falls within a low resolution range in terms of the communication volume, and different determinations are made, and thus it is determined to be normal.

On the other hand, as in the present embodiment, it is possible to detect an abnormality even in the case of the correlation 211 by performing a determination on the basis of the correlation in which the power supply amount and the communication volume are combined. Profiles of a plurality of types of devices scheduled to be connected to the PoE port 110 may be stored in the profile holding unit 180 in advance.

The correlation analyzing unit 190 may designate a profile to be used among the stored profiles of a plurality of types of devices or may acquire a type of PoE device connected to each PoE port 110 and use the profile in accordance with the acquired type of PoE device. The stored profile may be provided as a specification or the like from a device manufacturer or may be generated by an administrator.

In a case in which it is possible to power on or off the PoE device on the side of the PoE device connected to the PoE port 110, a circle 204 of a value determined to be normal may be set in the profile. With the circle 204, it is possible to prevent the PoE device from being erroneously determined to be abnormal when the PoE device is powered off.

The information of the profile may be, for example, bitmap data. Therefore, a region 223 may be configured with bits such as a bit 220 or a bit 221. In this example, “0” such as the bit 220 is a value determined to be abnormal, and “1” such as the bit 221 is a value determined to be normal. Since the correlation 212 corresponds to a bit 231 and has a value of “1,” it is determined to be normal, and since the correlation 211 corresponds to a bit 230 and has a value of “0,” it is determined to be abnormal.

In the example of FIG. 2, the bitmap is two-dimensionally indicated in association with a two-dimensional graph so that it is easily understood, but the bitmap is not limited to the two dimension, and any bitmap can be used as long as it is possible to calculate a position of a bit from the information of the power supply amount and the communication volume.

When the profile is indicated by the bitmap, it is possible to replace the circles 201, 202, and 203 with a free shape or increase the number of circles 201, 202, and 203, and it is possible to indicate a characteristic of the PoE device connected to the PoE port 110 accurately.

As long as it is possible to indicate the characteristic of the PoE device accurately, the information of the profile is not limited to the bitmap and may be data which is a two-dimensional map and capable of indicating a possible range using a two-dimensional space.

The number of profiles applied to the same PoE device or the same type of PoE devices may be two or more. For example, the frequency of use of an IP phone in an office largely changes depending on whether or not it is a business hour. In this regard, the profile holding unit 180 holds the profile during the business hours and the profile during the non-business hours in advance, and the profile holding unit 180 or the correlation analyzing unit 190 changes the profile serving as a determination criterion in accordance with a time. Since the conditions are limited as described above, it is possible to make a determination with a higher degree of accuracy.

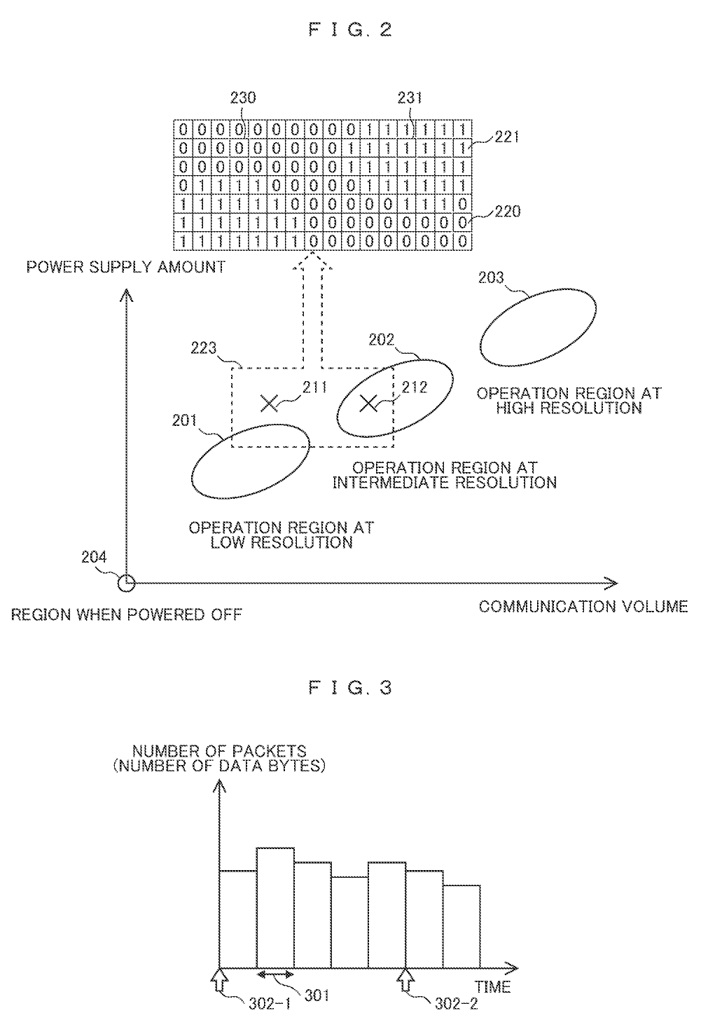

FIG. 3 is a diagram illustrating an example of the communication volume. As described above, the communication volume information recording unit 160 records the communication volume per unit time together with a timestamp. The unit time may be specified by the packet switching unit 130 or the PoE port 110, and in FIG. 3, the unit time is a unit time 301.

The communication volume per unit time 301 may be the number of packets which are output from or input to the PoE port 110 passing through the packet switching unit 130 or the number of data bytes of the packet or may be the number of packets passing through the PoE port 110 or the number of data bytes of the packet. Further, the discarded packet may be excluded from the communication volume.

The communication volume information recording unit 160 may record the communication volume per unit time 301 with the timestamp for each unit time 301 or may record a sum of the communication volume per unit time 301 from a time 302-1 to a time 302-2 including a plurality of unit times 301 together with the timestamp of the time 302-2.

Further, when the communication volume per unit time 301 is recorded together with the timestamp for each unit time 301, the correlation analyzing unit 190 may make a determination for each unit time 301 or may perform a determination at a timing such as the time 302-1 and the time 302-2 including a plurality of unit times 301 as an interval.

When the sum of the communication volumes per unit time 301 from the time 302-1 to the time 302-2 including a plurality of unit times 301 is recorded together with the timestamp of the time 302-2, the correlation analyzing unit 190 may perform a determination at a timing of the time 302-2 or perform a determination at a timing of a period longer than a period of the time 302-1 to the time 302-2.

When the period of the determination is longer than the period in which the timestamp is recorded, the correlation analyzing unit 190 may select the communication volume recorded together with the timestamp coinciding with a preset timing in the determination period and set the selected communication volume as the determination target.

When a plurality of timings is set in advance in one determination period, the correlation analyzing unit 190 may select the communication volumes recorded together with the timestamp coinciding with a plurality of set timings, determine a plurality of selected communication volumes, and give a notification indicating an abnormality to the CPU unit 150 when at least one of a plurality of determination results is determined to be abnormal.

In the example of FIG. 3, particularly, a relation between the communication volume and time is illustrated, but since a relation between the power supply amount and the time coincides with the relation between the communication volume and time, detailed description thereof is omitted.

Since it is possible to set the profile used for determining the abnormality in the two-dimensional map as described above, it is possible to set a fine profile. Particularly, since it is also possible to set the profile using the bitmap, it is possible to set a fine profile corresponding to a bit.

Accordingly, if the connected PoE device has a plurality of operation modes, it is possible to include content corresponding to each operation mode in the profile. Further, it is possible to determine that the power supply amount which is determined to be normal in another operation mode is abnormal without performing the erroneous determination. Further, it is also possible to take various countermeasure actions when it is determined to be abnormal.

### Second Embodiment

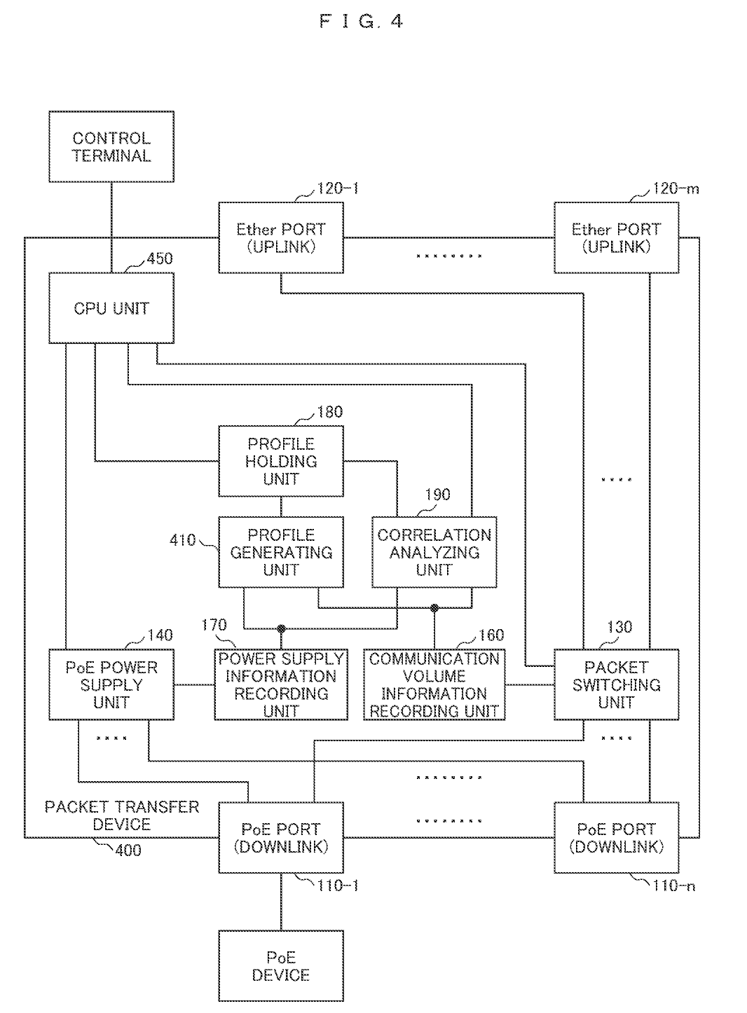

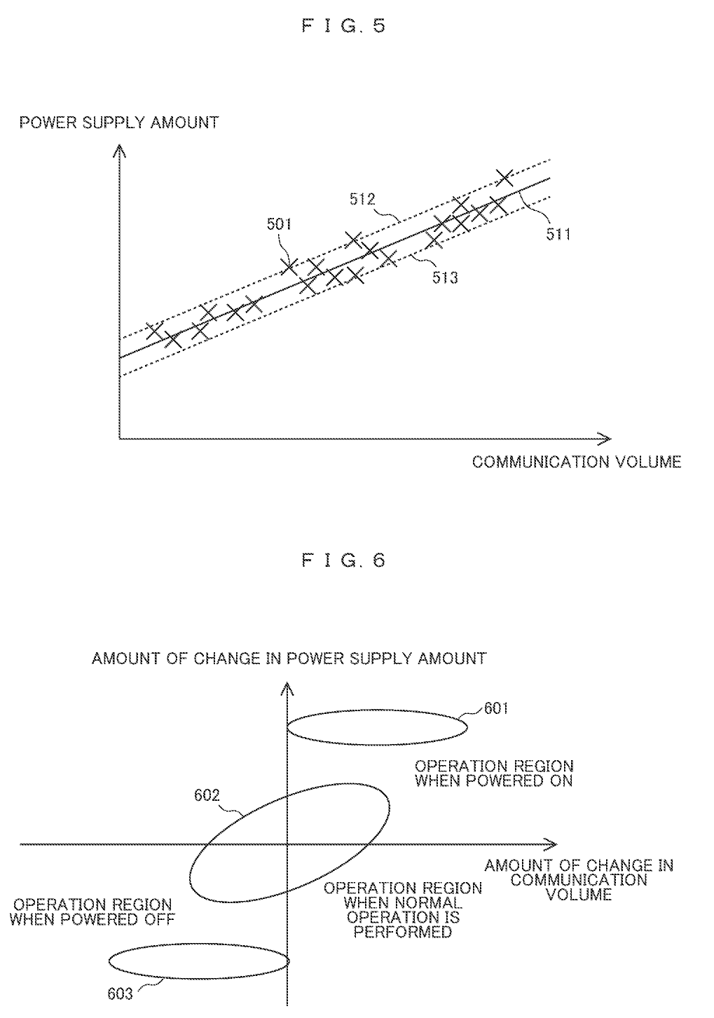

A second embodiment will be described with reference to FIGS. 4 and 5. In the second embodiment, the profile serving as the criterion for checking a normality of a PoE device to be connected is generated in the packet transfer device having the PoE function.

FIG. 4 is a block diagram illustrating an example of a packet transfer device 400 having a PoE function which is capable of checking a normality of a PoE device to be connected and capable of generating the profile serving as the criterion in the device. The packet transfer device 400 is based on the packet transfer device 100 illustrated in FIG. 1 and differs from the packet transfer device 100 illustrated in FIG. 1 in that a profile generating unit 410 that creates the profile in the device is added. Since the remaining components are the same as those described with reference to FIG. 1, the same reference numerals as those in FIG. 1 are given, and description thereof is omitted.

The profile generating unit 410 receives information from the communication volume information recording unit 160 and the power supply information recording unit 170 and generates the profile illustrated in FIG. 2 using a technique such as machine learning. Here, a period in which the profile is created, that is, a period until a normality criterion is decided is set as a learning period, and the normality determination is not performed during the learning period. A period in which the normality determination can be performed via the learning period is set as an operation period, and an operation in the learning period and an operation in the operation period are switched by an administrator via a CPU unit 450.

The profile generated by the profile generating unit 410 is stored in the profile holding unit 180. The correlation analyzing unit 190 reads the profile from the profile holding unit 180 and determines the normality of the device. Further, the generated profile is managed by the profile holding unit 180 and may be modified by the administrator via the CPU unit 450 if necessary.

FIG. 5 is a diagram illustrating an example of the profile generated with content different from that in FIG. 2. In the learning period, the profile generating unit 410 receives the information of the communication volume from the communication volume information recording unit 160, receives the information of the power supply amount from the power supply information recording unit 170, and records the communication volume and the power supply amount of the same timestamp as in a correlation 501.

The device that generates the profile is different, but the structure of the profile illustrated in FIG. 5 is identical to that in FIG. 2, and the correlation is indicated using a graph in FIG. 5, but it may be a bitmap data or may be a mathematical formula. The correlation 501 recorded in the learning period is distributed, for example, in a strip form as illustrated in FIG. 5. Therefore, if the device is a surveillance camera, the operation mode of the surveillance camera may be changed or an imaging target of the surveillance camera may be changed so that the communication volume changes during the learning period.

If the learning period ends, the profile generating unit 410 converts a plurality of recorded correlations 501 into a regression line 511 by a least squares technique or the like, calculates an upper limit line 512 which is a straight line having the same slope as the regression line 511 and higher in the power supply amount than a plurality of correlations 501 in each communication volume, and calculates and a lower limit line 513 which is a straight line having the same slope as the regression line 511 and lower in the power supply amount than a plurality of correlations 501 in each communication volume.

Then, the profile generating unit 410 generates a range surrounded by the upper limit line 512 and the lower limit line 513 as the profile determined to be normal. The profile may be a bitmap in which the range surrounded by the upper limit line 512 and the lower limit line 513 is “1,” and the other range is “0” or may be a mathematical formula.

When the profile is a mathematical formula, the mathematical formula may be a mathematical formula of the upper limit line 512 or a mathematical formula of the lower limit line 513 or may be the mathematical formula of the regression line 511 and a value indicating a range centering on the regression line 511. When the profile is the regression line 511 and a value indicating the range, profile generating unit 410 may not calculate the upper limit line 512 and the lower limit line 513.

Further, since a straight line close to the regression line 511 is set as training data in advance, the profile generating unit 410 may learn the upper limit line 512 and the lower limit line 513 through a plurality of correlations 501 on the basis of the training data. A profile of an n-th order function other than a linear function that becomes a straight line may be generated.

As described above, when the PoE device has a characteristic close to the linear function or the n-th order function in the correlation between the power supply amount and the communication volume, the packet transfer device 400 can generate the profile. Thus, it is possible to reduce a time and effort for generating the profile and improve the accuracy of the abnormality determination since the profile conforms to an actual characteristic of the PoE device.

### Third Embodiment

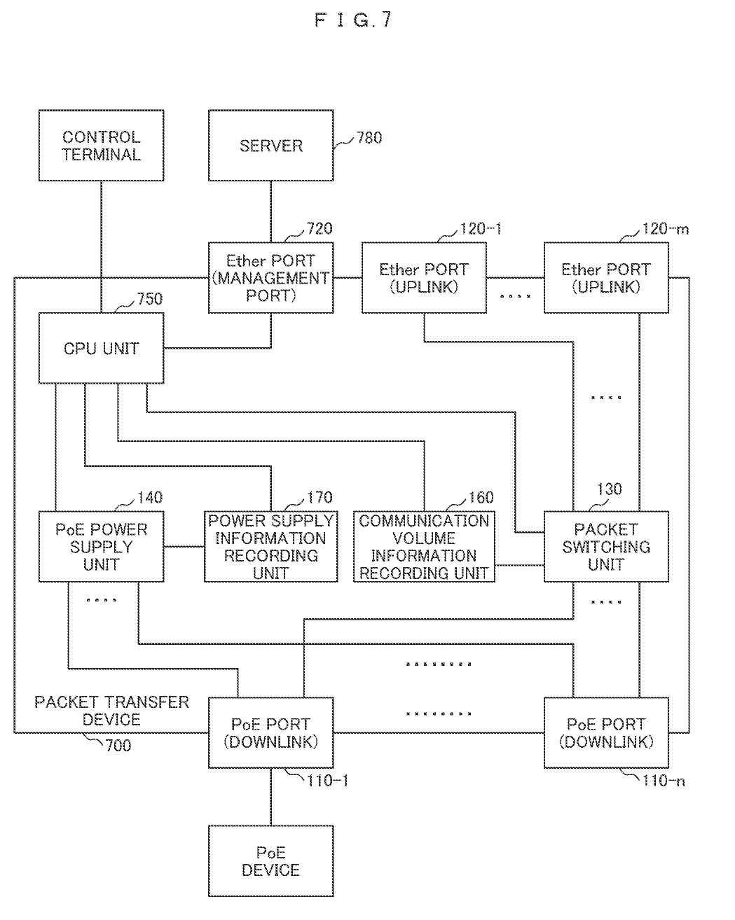

A third embodiment will be described with reference to FIG. 6. In the third embodiment, a criterion different from the criterion of the profile used as the determination criterion in the first and second embodiments is used. In the first and second embodiments, an evaluation axis of the profile is the communication volume and the power supply amount per unit time as illustrated in FIG. 2 or FIG. 5.

In the third embodiment, the evaluation axis is an amount of change in the communication volume per unit time and an amount of change in the power supply amount per unit time as illustrated in FIG. 6. Since a configuration of the packet transfer device having the PoE function is similar to that described with reference to FIG. 1 or FIG. 4, the same reference numerals as those in FIG. 1 or FIG. 4 are given, and description thereof is omitted. Further, data of the profile is a two-dimensional map as described with reference to FIG. 2.

FIG. 6 is a diagram illustrating an example of the profile of the amount of change. In the example of FIG. 6, values determined to be normal are surrounded by circles 601, 602, and 603, but they do not indicate the difference between the operation modes and correspond to states when the PoE device connected to the PoE port 110 is powered on, when the PoE device connected to the PoE port 110 is powered off, and when a normal operation is performed in the power OFF state.

The circle 601 corresponds to an operation region when the PoE device is powered on. When the PoE device is powered on, the power supply amount changes from zero before it is powered on to a high state by initialization immediately after it is powered on, and the communication volume also changes from zero before it is powered on to a communication state after it is powered on, and thus it becomes the range of the circle 601.

The circle 602 corresponds to the operation region in the normal operation. The PoE device enters a steady state when the operation of the PoE device is stabilized after the PoE device is powered on, and the communication volume and the power supply amount change in accordance with a change in a detailed operation of the PoE device, and thus it becomes the range of the circle 602. A state in which the PoE device is powered off also falls within the circle 602 because the communication volume and the power supply amount keep zero.

The circle 603 corresponds to the operation region when the PoE device is powered off. If the PoE device is powered off, the communication volume and the power supply amount change to zero after the PoE device is powered off, and thus it becomes the range of the circle 603.

The amount of change in the communication volume per unit time may be a difference between the communication volume at the time 302-1 and the communication volume at the time 302-2, for example, when the time 302-1 and the time 302-2 are used as the reference for calculation of the amount of change. The amount of change in the power supply amount per unit time may also be a difference when the same reference as in the communication volume is used.

As described above, in order to acquire the amount of change in the communication volume per unit time and the amount of change in the power supply amount per unit time, the correlation analyzing unit 190 may acquires the communication volume and the power supply amount of the time stamp corresponding to the time 302-1 and the time 302-2 from among the communication volumes recorded in the communication volume information recording unit 160 and the power supply amounts recorded in the power supply information recording unit 170 and calculate the difference.

Since the amount of change in the communication volume and the amount of change in the power supply amount are considered, it is possible to detect, for example, a case in which, when the device is taken over, the power consumed is increased by repetitive unauthorized operations although the communication volume is not increased.

### Fourth Embodiment

A fourth embodiment will be described with reference to FIG. 7. The profile holding unit 180, the profile generating unit 410, and the correlation analyzing unit 190 which are installed in the packet transfer device having the PoE function in the first to third embodiments are arranged in a server 780 outside a packet transfer device 700 having the PoE function in the fourth embodiment.

FIG. 7 is a block diagram illustrating an example of the packet transfer device 700 having the PoE function cooperating with the server 780 in order to check the normality of the connected PoE device. Since the remaining components except for a component related to the server 780 are similar to those described with reference to FIGS. 1 to 6, the same reference numerals as those in FIGS. 1 to 6 are given, and description thereof is omitted.

The packet transfer device 700 transmits the communication volume and the power supply amount which are measured and recorded in the device to the external server 780 via a CPU unit 750 and an Ether port 720. In this case, the communication volume and the power supply amount are transmitted together with an identifier indicating the PoE port 110 and the packet transfer device 700 related to the information. If identification information of the PoE device connected to the PoE port 110 is obtained, the identification information of the PoE device may be transmitted.

The external server 780 generates the profile on the basis of the received information if the profile is not set in advance. A process of generating the profile is similar to that described in the second embodiment. The server 780 holds a generated or preset profile, and determines the normality on the basis of the profile and the received information of the communication volume and the power supply amount. A normality determination process is similar to that described in the first to third embodiments.

When an abnormality is detected as a result of determination, the server 780 gives a notification indicating the occurrence of an abnormality and the identifier of the PoE port 110 determined to be abnormal to the packet transfer device 700. The CPU unit 750 receives the notification via the Ether port 720 and takes an action as described in the first embodiment.

A single server 780 may undertake tasks of profile management and normality checking of a plurality of packet transfer devices. Further, the control terminal may be installed in the server 780. Further, the packet transfer device 700 and the server 780 may be collectively referred to as a “packet transfer system.”

As described above, since the server 780 executes the processes of the profile holding unit, the correlation analyzing unit, and the like, it is possible to reduce the processing load of the packet transfer device 700 to be smaller than in the packet transfer devices 100 and 400 and implement with inexpensive hardware. Further, since the process is performed by the server 780, it is possible to perform a more complicated process than in the packet transfer device 400 when generating the profile.

### Fifth Embodiment

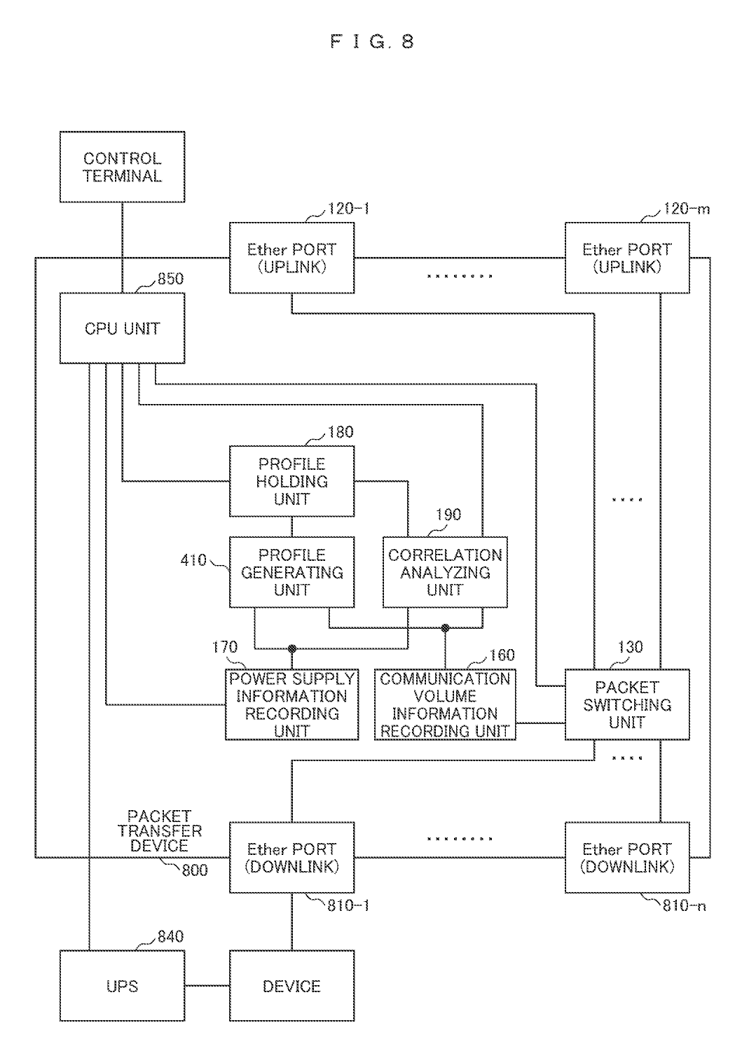

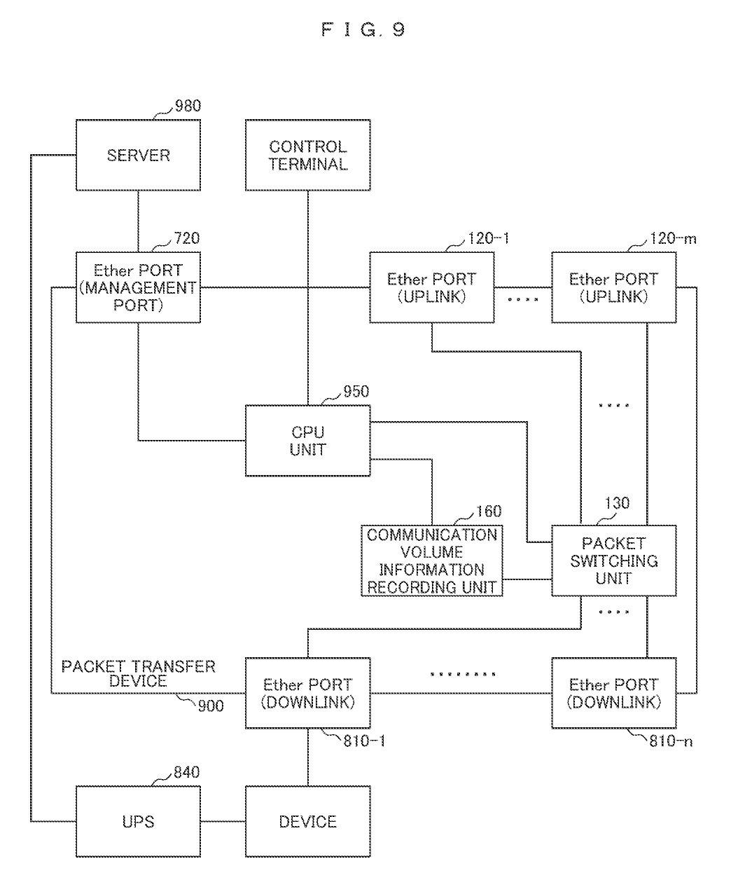

A fifth embodiment will be described with reference to FIGS. 8 and 9. In the fifth embodiment, a packet transfer device does not have a PoE function, a UPS 840 (power supply unit) is arranged outside a packet transfer device 800, and electric power is supplied from the UPS 840 to the device.

FIG. 8 is a block diagram illustrating an example of the packet transfer device 800 capable of checking a normality of a connected device in cooperation with the UPS 840. The packet transfer device 800 is based on the packet transfer device 400 illustrated in FIG. 4 and differs from the packet transfer device 400 illustrated in FIG. 4 in that the packet transfer device 800 includes no PoE power supply unit in the device, and a CPU unit 850 is connected to the UPS 840.

Further, since the packet transfer device 800 includes no PoE power supply unit, an Ether port 810 is installed as a downlink port instead of a PoE port, and a device is connected. Since the remaining components are similar to those described with reference to FIG. 4, the same reference numerals as those in FIG. 4 are given, and description thereof is omitted.

The UPS 840 supplies electric power to the device and measures the power supply amount. Therefore, the UPS 840 is used as an alternative to the PoE power supply unit 140. The UPS 840 transmits the information of the measured power supply amount to the CPU unit 850 together with the measurement timestamp and the identifier of the device of the power supply target. In the example of FIG. 8, the UPS 840 supplies electric power to a single device but may supply electric power to a plurality of devices.

Upon receiving the information of the power supply amount, the CPU unit 850 transmits the information related to the received power supply amount to the power supply information recording unit 170 instead of the PoE power supply unit 140, and then the operation described in the second embodiment is performed. The packet transfer device 800 and the UPS 840 may be collectively referred to as a “packet transfer system.”

FIG. 9 is a block diagram illustrating an example of a packet transfer device 900 cooperating with the UPS 840 and a server 980. The packet transfer device 900 is based on the packet transfer device 700 illustrated in FIG. 7 and differs from the packet transfer device 700 illustrated in FIG. 7 that the PoE power supply unit and the power supply information recording unit are not installed in the device, and the server 980 is connected to the UPS 840. Since the remaining components are similar to those described with reference to FIGS. 7 and 8, the same reference numerals as those in FIGS. 7 and 8 are given, and description thereof is omitted.

The UPS 840 transmits the information of the measured power supply amount to the server 980 together with the measurement timestamp and the identifier of the device of the power supply target. The server 980 receives the information related to the communication volume which are measured and recorded in the device via a CPU unit 950 and an Ether port 720 and performs the same process as in the server 780 illustrated in FIG. 7. The packet transfer device 900, the server 980, and the UPS 840 may be collectively referred to as a “packet transfer system.”

As described above, it is possible to connect devices other than the PoE device, and it is possible to generate the profile and determine the normality even when electric power is supplied from the UPS 840 to the device.

1. A packet transfer device including a PoE port, comprising:
a power supply unit that controls power supply to the PoE port and measures a power supply amount;
a packet switching unit that transfers a packet via the PoE port and another port of the packet transfer device and measures a communication volume of the PoE port;
a profile holding unit that holds a profile indicating a normal operation region of a device connected to the PoE port using a map of a correlation of the power supply amount and the communication volume;
a correlation analyzing unit that determines whether or not the device is abnormal on the basis of the power supply amount measured by the power supply unit, the communication volume measured by the packet switching unit, and the profile held in the profile holding unit; and
a CPU unit that controls the respective units of the packet transfer device and performs a countermeasure action on the basis of the determination of whether or not the device is abnormal by the correlation analyzing unit.

2. The packet transfer device according to claim 1, wherein the profile holding unit holds a profile indicated by a bitmap in which a value of each bit included in the normal operation region indicates a normal operation, and a value of a bit included in a region other than the normal operation region indicates an abnormal operation, and
the correlation analyzing unit calculates a bit position of the bitmap from the power supply amount measured by the power supply unit and the communication volume measured by the packet switching unit, reads a value of a bit at the calculated bit position, and determines whether or not the device is abnormal.

3. The packet transfer device according to claim 2, wherein the CPU unit performs one or more of countermeasure actions including trap issuing of a simple network management protocol (SNMP), transmission of syslog information, notification of information via an e-mail, blocking of communication, interruption of power supply to a port determined to be abnormal, and mirroring of communication related to a port determined to be abnormal to another port on the basis of the determination of whether or not the device is abnormal by the correlation analyzing unit.

4. The packet transfer device according to claim 3, further comprising,
a profile generating unit that calculates a linear function or an n-th order function on the basis of the power supply amount measured by the power supply unit and the communication volume measured by the packet switching unit, generates a bitmap on the basis of the calculated linear function or the n-th order function, and generates a profile.

5. The packet transfer device according to claim 3, further comprising:
a power supply information recording unit that records the power supply amount measured by the power supply unit together with a time; and
a communication volume information recording unit that records the communication volume measured by the packet switching unit together with a time,
wherein the correlation analyzing unit calculates an amount of change with respect to the time of the power supply amount recorded by the power supply information recording unit, calculates an amount of change with respect to the time of the communication volume recorded by the communication volume information recording unit, calculates the bit position of the bitmap from the calculated amount of change in the power supply amount and the calculated amount of change in the communication volume, reads a value of a bit at the calculated bit position, and determines whether or not the device is abnormal.

6. The packet transfer device according to claim 3, wherein the profile holding unit holds an operation region when the device is powered on, an operation region when a normal operation is performed, and an operation region when the device is powered off as the normal operation region of the device.

7. The packet transfer device according to claim 3, wherein the profile holding unit holds a plurality of bitmaps each indicating the profile, and
the correlation analyzing unit changes the bitmap to be used from among the plurality of bitmaps in accordance with the time and reads the value of the bit at the calculated bit position in the bitmap to be used.

8. A packet transfer system, comprising:
a packet transfer device including
a port
a packet switching unit that transfers a packet via the port and another port of the packet transfer device and measures a communication volume of the port, and
a CPU unit that controls the respective units of the packet transfer device and transmits the communication volume measured by the packet switching unit to a server;
the server that holds a profile indicating a normal operation region of a device connected to the port using a map of a correlation of a power supply amount and a communication volume and determines whether or not the device is abnormal on the basis of a received power supply amount, a received communication volume, and the held profile; and
a power supply unit that controls power supply to the device and measures and transmits the power supply amount.

9. The packet transfer system according to claim 8, wherein the power supply unit is installed in the packet transfer device, and controls power supply to the device via the port and transmits the measured power supply amount to the CPU unit via the CPU unit, and the CPU unit further transmits the power supply amount transmitted by the power supply unit to the server.

10. The packet transfer system according to claim 8, wherein the power supply unit is installed outside the packet transfer device, and transmits the measured power supply amount to the server.
